(19) United States
(12) Patent Application Publication
(10) Pub. No.: US 2018/0363624 A1
(43) Pub. Date: Dec. 20, 2018

(54) WIND TURBINE WITH PAIRS OF BLADES TO DEFLECT AIRFLOW

(71) Applicant: Arken S.P.A., Ferentino (IT)

(72) Inventors: Valerio Focanti, Roma (IT); Marco Profili, Terni (IT); Moreno Rotondi, Sora (IT)

(21) Appl. No.: 15/623,248

(22) Filed: Jun. 14, 2017

(51) Int. Cl. F03D 3/00; F03D 3/06; F03D 7/06

(52) U.S. Cl. CPC F03D 3/005; F03D 3/064; F03D 7/06; F03D 3/061

(57) ABSTRACT

A wind turbine with a vertical axis includes a base; a central shaft; and a rotor operationally engaging the central shaft. The rotor is rotatable relative the central shaft, and coaxial therewith about the vertical axis. The rotor includes a plurality of pairs of blades, each pair of blades including a larger outer blade and a smaller inner blade. The outer and inner blades define at least one diverting and distribution channel for a laminar flow effect induced by the inner blade against the outer blade, involving a delay in the detachment of the air flow from the edge of the surface of the outer blade, allowing the turbine to operate in wind having a speed about 2 m/s.

### BACKGROUND

The present invention relates generally to wind turbines. More particularly, the present invention is directed to a vertical axis wind turbine.

Wind is the perceptible natural movement of air, especially in the form of a current of air blowing from a particular direction. Over the course of history, people have sought to harness wind power or wind energy (i.e., the kinetic energy of wind) for various purposes. For example, windmills have been used to convert wind energy into mechanical energy for centuries.

In modern times, due to concerns about climate change brought about by the burning of fossil fuels, and the desire to decrease reliance on fossil fuels for energy production, there has been an increasing drive to harness wind power by converting wind energy into electrical energy through the use of wind turbines. When thinking of wind turbines, an image comes to mind of a large wind turbine over one hundred meters high, either standing alone or as part of an array of other large wind turbines in a so-called “wind farm.” However, wind turbines come in all sizes. A small or micro-wind turbine is used for microgeneration of electricity for domestic or small-scale commercial consumption, as opposed to the large wind turbines used in commercial wind farms for large-scale energy production.

Contemporary micro-wind turbines are split into two turbine designs, each with their own benefits and limitations: the horizontal axis wind turbine (HAWT); and the vertical axis wind turbine (VAWT). The HAWT can launch in some low wind conditions (i.e., less than six (6) meters per second (m/s) (approximately twenty (20) feet per second (ft/s))), but is subject to high wear, low efficiency, and overall yields, and wind orientation issues. The VAWT is more efficient than the HAWT but does not launch in low-speed wind conditions. A HAWT needs to be pointed into the wind (i.e., in the direction the wind is coming from), whereas a VAWT does not.

Micro-wind turbines are designed for use in various environments including urban, suburban, rural, and wilderness environments. However, one problem is that wind conditions within each environment can vary greatly, and the overall general wind conditions in each environment can be quite different from those found in the other environments. The variability of wind conditions greatly limits the effectiveness of fixed structure micro-wind turbines (i.e. turbines that cannot be modified) that could work with an acceptable efficiency during a certain period of a particular day, but then have a very low efficiency at another time later on during that same day. For example, wind intensity (e.g., wind speed) varies continuously. Wind speed is caused by air moving from high pressure to low pressure, usually due to changes in temperature. The greater the difference in pressure, the faster the wind flows (from the high to low pressure) to balance out the variation between the high and low pressures. This difference in pressure can be referred to as the pressure gradient (i.e., the difference in pressure between two points). The pressure gradient (along with other factors such as terrain conditions) influences wind direction. Thus, a wind turbine that cannot launch at low speed may not be practical in an area where wind speed varies continuously between high and low.

Another problem is operating range limits. The rotation rate of a micro-wind turbine defines its power output. Current wind generators are tied to an “operating band” between their cut-in speed (i.e., where they begin to generate electricity) and their cut-out speed (i.e., where the wind speed is too high and generating power would damage the turbine). This maximum operating speed, coupled with poor productivity rates at lower wind speeds, is a significant contributing factor to the limited “productive time” of wind turbines.

Yet another problem is poor productivity. Due to their design factors, derived from large turbines, contemporary micro-wind turbines generate more power in faster winds, but generate little to no electricity in winds lower than 6 m/s. It is estimated that most of the time (e.g., approximately 60% of the time), domestic micro-wind turbines operate in these unfavorable conditions due to the dramatic effect that buildings have on the air flow in the atmospheric boundary layer of their target residential areas. In this situation, commercially available micro-turbines exploit only 20% of their working potential, often due to their wing design and material composition.

An additional problem is financial cost. Current solutions on the market are expensive for homeowners. For example, the average price of a 1 kW micro-wind turbine can be between approximately $3200-6400 (about €3000-6000), plus installation and maintenance costs, factors that have limited their adoption. Additionally, the payback period of current micro turbines is currently over ten (10) years, making them a poor investment overall.

Yet another problem is environmental cost. Current domestic wind turbines are large and generate noise as a necessary side-effect of how they function, with heat and noise being waste by-products of electricity generation. This constant noise (e.g., 50-66 dB compared to ambient noise levels of 43.8 dB—an increase of 10 dB indicates that the noise level has doubled) and an often-intimidating form factor makes contemporary turbines an uninviting prospect for urban and suburban households.

A further problem is negative reputation. Due to various factors (e.g., large initial investment, negative effects on the environment, and performance limitations), domestic wind power generation has earned a reputation as unreliable and unstable; installers rarely recommend micro-wind turbines as a solution to an end-user's power generation needs as they cannot guarantee their performance or payback period.

Different types of wind turbines have been proposed to harness wind power. In one example, German Patent No. DE3130507 proposes a vertical-axis wind turbine having a rotor provided with coupled blades, having a profile inspired by the aeronautic field, in which the position and the relative angle of the blades is fixed and defines a channel within which an acceleration of the airflow is created and, by Venturi effect, a lift on the blades facilitating the start of the rotor motion. In another example, in order to improve the performance of a wind turbine of the same type as German Patent No. DE3130507, German Patent No. DE3607278 suggests that the angle of incidence of the inner blades of each pair of blades is lower than the angle of incidence of external blades. In a further example, German utility model patent No DE29608787, a wind turbine of the same type of those described in German Patent Nos. DE3130507 and DE3607278, discloses that each pair of blades is provided on arms having a different length.

The above-described solutions disclose wind turbines able to exploit wind potential, using a deviation and distribution channel defined by the positioning of the two blades constituting each single pair. However, such wind turbines have their limitations and can always be improved. The above-described solutions do not disclose a wind turbine able to exploit the maximum advantage of wind potential at a low speed, as well as to be able to independently initiate at very low wind speeds.

In this context, there is a need for a wind turbine that is able to exploit maximum advantage of the wind potential at a low speed, able to effectively adapt to every wind condition, using a channel of deviation and distribution, defined by the positioning of the two blades constituting a single pair, so as to exploit a laminar fluid effect created, under certain conditions, within the deviation and distribution channel. There is also a need for a wind turbine where the amplitude and the shape of the deviation and distribution channel can be changed by changing the relative position of the two blades of each pair of the turbine blades. Furthermore, there is a need for a wind turbine that provides a lift wind turbine, having non-twisted vertical axis and blades, structured in such a way as to be self-starting at very low wind speeds, due to the presence of the deviation and distribution channel and, optionally, the ability to modify its amplitude and shape by changing the relative position of the two blades of each pair of the turbine blades. There is a further need for providing lift wind turbines, having a vertical axis, allowing to overcome the limits of the turbines according to the prior art and to achieve the technical results described in the above. There is an additional need for a wind turbine that is low cost in terms of production costs and management costs. There is a need for a vertical axis, lift wind turbine that is simple, safe and reliable. There is an additional need for a wind turbine that is easier to manufacture, assemble, adjust, and maintain. The present invention satisfies these needs and provides other related advantages.

### SUMMARY

The present invention is directed to a vertical axis wind turbine with a plurality of pairs of non-twisted blades, where the pairs of blades are arranged so as to form a channel able to deflect and distribute the flow of the wind so as to realize an energy advantage that increases overall performance. The micro-wind turbine assembly illustrated herein provides an efficient and reliable micro-wind turbine for the production of electricity from lower quality winds in various locations (e.g., urban locations, locations where wind is infrequent and/or rarely strong, etc.). The micro-turbine assembly illustrated herein offers superior efficiency in power generation, by starting to operate with low wind speeds (e.g., about two (2) m/s).

The micro-wind turbine assembly illustrated herein generates power even in poor-quality wind conditions, able to provide small electricity to an end-user in wind speeds at six (6) m/s (e.g., common urban winds), and can even start to generate power in winds of three (3) m/s or less, preferably in winds of about two (2) m/s. As these low-quality wind conditions can make up 60% or more of wind per year in the end-user environment, the micro-turbine assembly provides performance by always delivering a positive torque and a relevant power coefficient, even when wind speed is about two (2) m/s.

The micro-wind turbine assembly illustrated herein provides efficiency and performance, even in the low wind speed conditions (<6 m/s) that account for more than 60% of wind annually. This efficient domestic energy production allows the user to reduce its dependence on power from grids along with energy-related residential greenhouse gas (GHG) emissions. The savings from this increase in household efficiency makes the wind micro-turbine assembly illustrated herein a cost-effective solution.

The micro-wind turbine assembly illustrated herein converts wind energy to electrical energy by using the wind to turn a rotor (e.g., blades attached to a central hub), which is connected to an outer rotor type generator (the speed of the rotor as it rotates being governed by the wind speed, number of blades and blade geometry). The rotor of the turbine speed rotates between around 200 to 300 RPM to generate power with the outer rotor type generator.

The power output of an engine is expressed as its torque multiplied by the rotational speed of its axis. The micro-wind turbine assembly illustrated herein exploits low wind speed, thus low rotational engine speed. In order to obtain a maximum power of 1 KW with low speed, a high torque is employed by leveraging a blade and turbine design derived from aerodynamic and sailing techniques and studies.

In particular, the present invention relates to a micro-wind turbine, i.e. a device able to convert the wind kinetic energy into electrical energy, in order to generate output power lower than 20 kW.

The micro-wind turbine here suggested has a configuration of the pairs of blades such that it can effectively exploit all wind conditions.

In accordance with another embodiment of the invention, a wind turbine with a vertical axis, includes a base; a central shaft; and a rotor operationally engaging the central shaft. The rotor is rotatable relative to the central shaft, and is coaxial therewith about the vertical axis. The rotor includes a plurality of pairs of blades, with each pair of blades including a larger outer blade and a smaller inner blade. The outer and inner blades define at least one diverting and distribution channel for a laminar flow effect induced by the inner blade against the outer blade, involving a delay in the detachment of the air flow from the edge of the surface of the outer blade, allowing the turbine to operate in wind having a speed about 2 m/s.

Particularly, in the Tip Speed Ratio (TSR) range of 0≤λ≤4, in which TSR indicates the ratio of the tangential speed of the blades and the actual speed of the wind, the operative parameters of the pairs of blades are:
the ratio of the maximum chord of the outer blade c2 and maximum chord of the inner blade c1 is equal to 0.10≤c1/c2≤1;
the distanced between point A located on the maximum chord of the outer blade, at a distance equal to ¼ of the length c2 of the maximum chord from the leading edge of the outer blade and point B located on the maximum chord of the inner blade, at a distance equal to ¼ of the length c1 of the maximum chord from the leading edge of the inner blade is equal to: 0.5c1≤d≤2c2
the angle of incidence γ formed between the extension of the chord of the outer blade and the extension of the chord of the inner blade: 0≤γ≤45°.

In accordance with an embodiment of the present invention, the inner blade of each pair of blades operationally engages the rotor in a manner that allows a position of the inner blade to be adjusted relative to a position of the outer blade.

In accordance with another embodiment of the present invention, the rotor includes a plurality of articulated arms, wherein each arm operationally connects a particular one of the pairs of blades to the rotor.

In accordance with yet another embodiment of the present invention, the movement of the articulated arms is controlled by an electronic processor operationally connected to an anemometer for adjusting positions of the inner blade relative to the outer blade upon detecting a change in wind speed.

In accordance with a further embodiment of the present invention, the rotor includes an upper arm assembly and a lower arm assembly, wherein each arm assembly includes a plurality of arms, wherein each arm engages a particular one of the pairs of blades. Each arm of the plurality of arms includes a winglet at an end distal from the central shaft, wherein each blade of a particular pair of blades associated with a particular arm extends through and operationally engages the winglet associated with that particular arm.

In accordance with an additional embodiment of the present invention, the rotor includes a plurality of wheels disposed about the vertical axis, and wherein each wheel operationally engages an external surface of the central shaft.

In accordance with still another embodiment of the present invention, each pair of blades includes an upper winglet attached to top surfaces of the inner and outer blades, and a lower winglet attached to the bottom surfaces of the inner and outer blades.

In accordance with yet another embodiment of the present invention, each outer blade of the pairs of blades includes a flange extending laterally away from a trailing edge of the outer blade, whereby the flange acts as a Gurney Flap.

In accordance with an embodiment of the present invention, at least the inner blade is coupled to the rest of the structure of the turbine by means of mechanical connections apt to allow its displacement, so as to vary the mutual position of the outer blade with respect to an inner blade. The mechanical connections include articulated arms, and can be controlled by automated means, where the automated means are operationally connected to an electronic processor that is, in turn, operationally connected to an anemometer.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The various present embodiments now will be discussed in detail with an emphasis on highlighting the advantageous features with reference to the drawings of various embodiments. The illustrated embodiments are intended to illustrate, but not to limit the invention. These drawings include the following figures, in which like numerals indicate like parts:

FIG. 1 illustrates a perspective view of a vertical axis wind turbine with a plurality of pairs of blades, according to an embodiment of the present invention;

FIG. 2 illustrates a front view of the vertical axis wind turbine of FIG. 1;

FIG. 3 illustrates an enlarged view of a portion of the vertical axis wind turbine of FIG. 1 taken along line 3 of FIG. 2;

FIG. 4 illustrates a top plan cross-sectional view of the wheel assembly of the lower arm assembly of the vertical axis wind turbine of FIG. 1 taken along line 4-4 of FIG. 3;

FIG. 5 illustrates an enlarged view of a portion of the vertical axis wind turbine of FIG. 1 taken along line 5 of FIG. 2;

FIG. 6 illustrates a bottom plan cross-sectional view of the central shaft of the vertical axis wind turbine of FIG. 1 taken along line 6-6 of FIG. 5;

FIG. 7A illustrates a top plan cross-sectional view of the vertical axis wind turbine of FIG. 1 taken along line 7A-7A of FIG. 2;

FIG. 7B illustrates an enlarged top plan cross-sectional view taken along line 7B of FIG. 7A

FIG. 8 illustrates an exploded perspective view of an outer blade and a flange serving as a Gurney Flap of a vertical axis wind turbine;

FIG. 9 illustrates a side cross-sectional view of the blade and the flange serving as a Gurney Flap of FIG. 8;

FIG. 10 illustrates a schematic plan drawing of a pair of blades of a wind turbine according to the present invention;

FIG. 11 illustrates a diagram of the power variation (expressed in W) as a function of the rotation speed (expressed in revolutions per minute) of a rotor/impeller arrangement of a micro turbine having three single blades and three different rotor/impeller arrangements of a micro turbines having three pairs of blades, as represented in the schematic plan drawing, represented aside the diagram;

FIG. 12 illustrates a diagram of the torque variation (expressed in Nm) as a function of the rotation speed (expressed in revolutions per minute) of a single blade micro turbine and of the three different arrangements of micro turbines with pairs of blades of FIG. 11;

FIG. 13 illustrates a diagram of the variation of the torque (expressed in Nm) as a function of the applied load (expressed in Ohms) of a single blade micro turbine and of the three different arrangements of the micro turbines with pairs of blades of FIG. 11;

FIG. 14 illustrates a diagram of the variation of the power (expressed in W) as a function of wind speed (expressed in m/s) of a single blade micro turbine and of a micro turbine according to the present invention;

FIG. 15 illustrates a diagram of the variation of the torque (expressed in Nm) as a function of wind speed (expressed in m/s) of a micro turbine having a three single blade arrangement and of a micro turbine having according to the present invention having a three pairs of blades arrangement;

FIG. 16 illustrates a perspective view of a vertical axis wind turbine with a plurality of pairs of blades, according to a first embodiment of the present invention; and

FIG. 17 illustrates a perspective view of a vertical axis wind turbine with a plurality of pairs of blades, according to a second embodiment of the present invention.

### DETAILED DESCRIPTION

The following detailed description describes present embodiments with reference to the drawings. In the drawings, reference numbers label elements of present embodiments. These reference numbers are reproduced below in connection with the discussion of the corresponding drawing features.

It is to be understood that the figures and descriptions of the present invention have been simplified to illustrate elements that are relevant for a clear understanding of the present invention, while eliminating, for the purpose of clarity, many other elements found in micro-wind turbines. Those of ordinary skill in the pertinent arts may recognize that other elements and/or steps are desirable and/or required in implementing the present invention. However, because such elements and steps are well known in the art, and because they do not facilitate a better understanding of the present invention, a discussion of such elements and steps is not provided herein. The disclosure herein is directed to all such variations and modifications to such elements and methods known to those skilled in the pertinent arts.

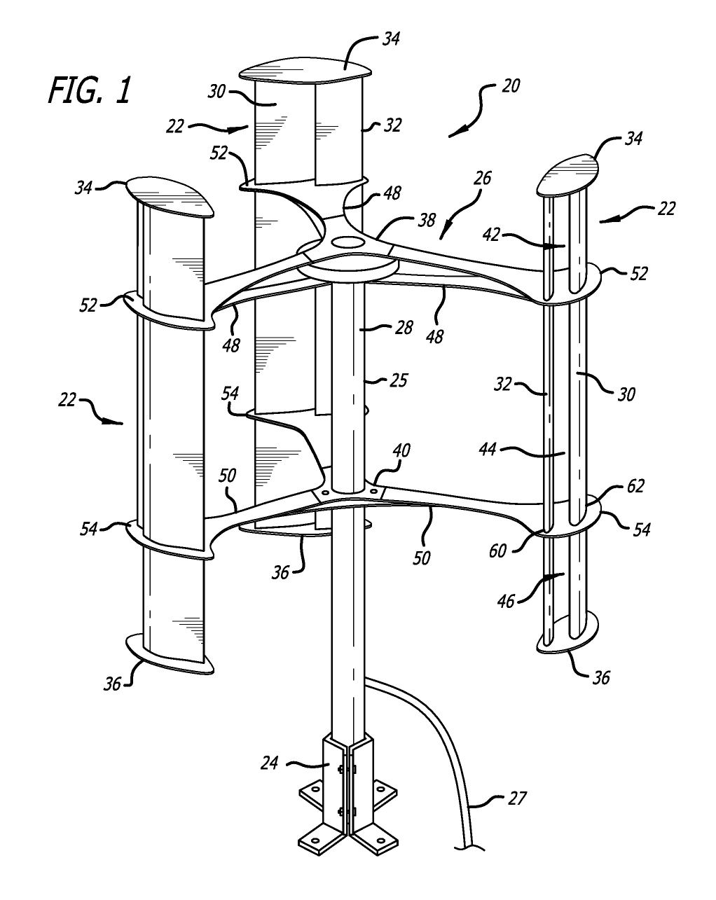

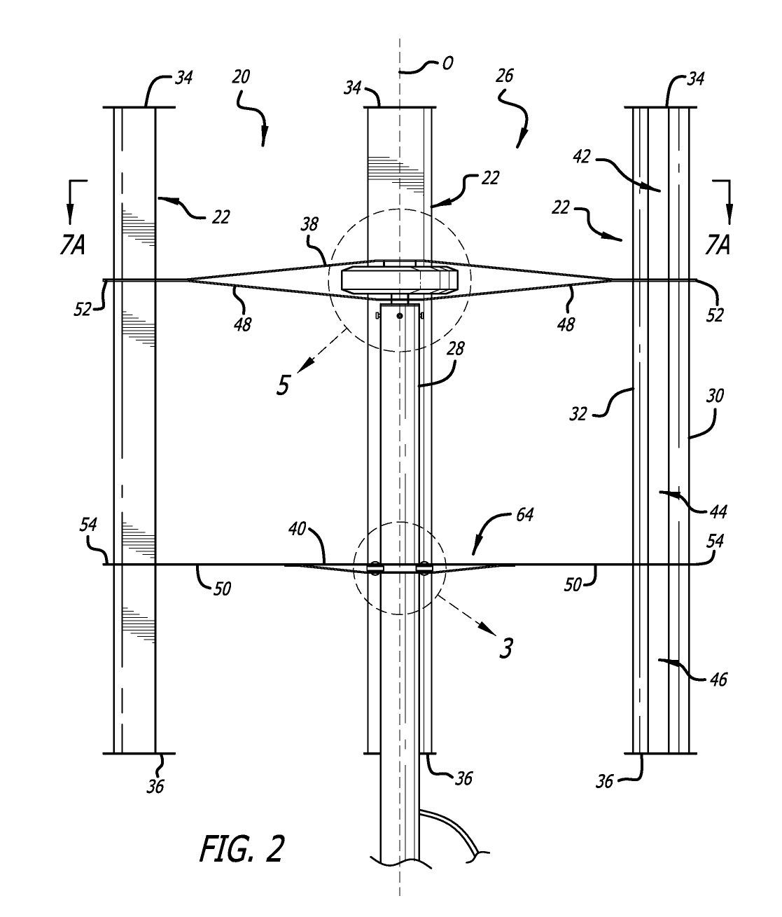

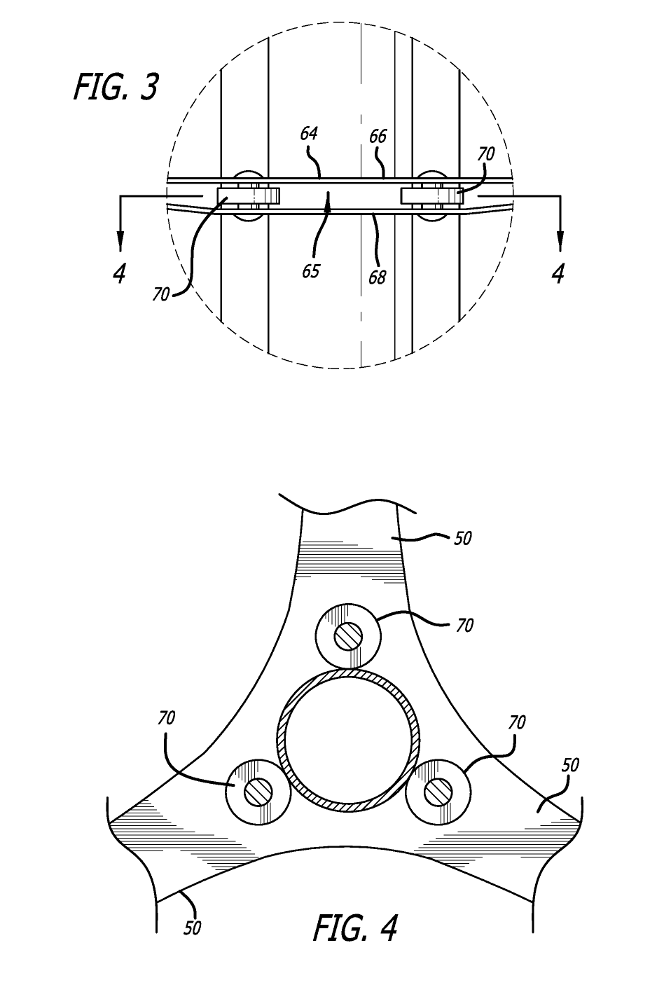

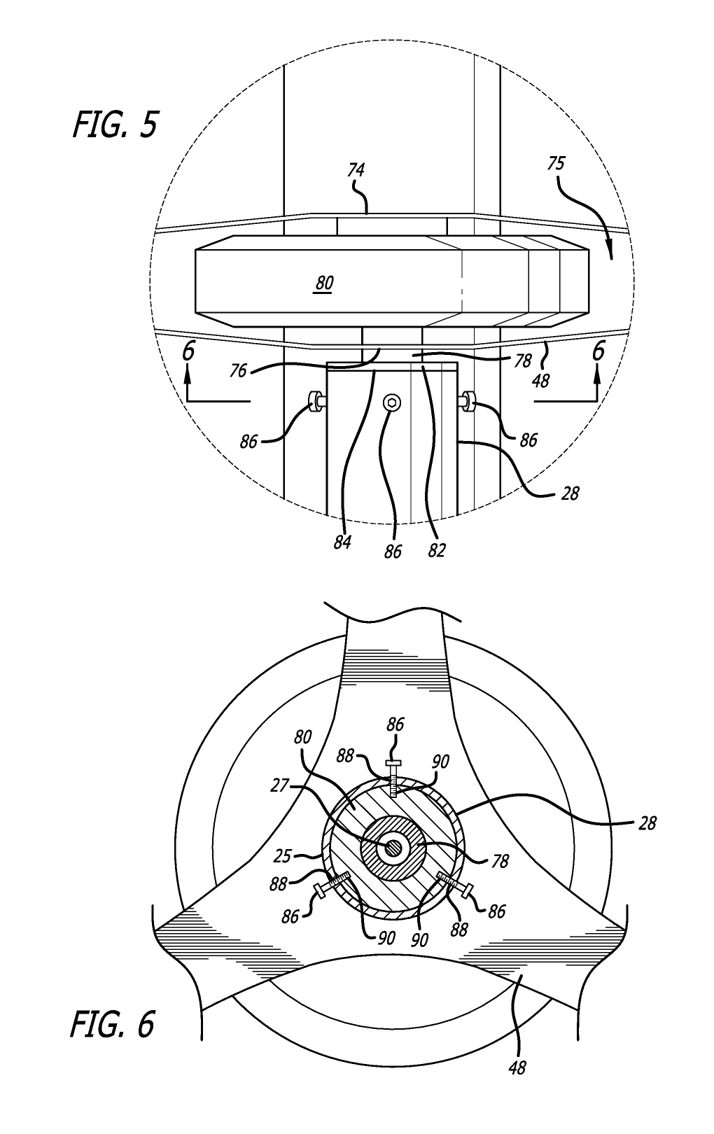

As shown in FIGS. 1-7B for purposes of illustration, an embodiment of the present invention resides in a micro-wind turbine in the form of a vertical axis wind turbine assembly 20 having a plurality of pairs of blades 22. The assembly 20 may be made from various materials including, but not limited to, metal, plastic, carbon-fiber composites or the like. For example, various parts of the assembly 20 can be made from either polypropylene or polyethylene (HDPE).

The assembly 20 includes a pedestal 24, a tubular central pole or support 25 extending upwards from the pedestal 24, and an operating unit 26 supported by and operationally engaging the central support 25. The operating unit 26 is configured to rotate about a vertical axis O. The vertical axis O is co-axial with a longitudinal axis of the central support 25. A electrical cable 27 transmits electrical energy generated by the assembly 20 from the assembly 20 to a battery, or electrical grid.

The operating unit 26 includes a central hub 28, rotating around the vertical axis O, and three (3) pairs of blades 22. Each pair of blades 22 includes an external or outer blade 30 and an internal or inner blade 32. Both the outer blades 30 and the inner blades 32 have an airfoil shape with an inner surface facing towards the vertical axis O. The shape and dimensions of the blades 30, 32 are determined by the aerodynamic performance required to efficiently extract energy from the wind, and by the strength required to resist the forces on the blade 30, 32. The inner and outer blades 32,30 have the same airfoil shape. The outer blade 30 is larger than the internal blade 32. The ratio of the inner blade 32 to the outer blade 30 is ⅗. The space between the outer blade 30 and the inner blade 32 of each pair of blades 22 defines an airflow diversion and distribution channel incident on the pair of blades 22. The blades 30, 32 may be made from various materials including, but not limited to, metal, plastic, carbon-fiber composites or the like.

Each pair of blades 22 is disposed in a fixed manner, and is respectively coupled to an upper end flap or upper winglet 34 at an upper end of the pair of blades 22 and to a lower end flap or lower winglet 36 at a lower end of the pair of blades 22. The winglets 34, 36 reduce induced drag as the winglets 34, 36 reduce trailing vortices as the pairs of blades 22 rotate about the vertical axis O. Each winglet 34, 36 is sized and shaped to provide the best results in terms of strengthening and energy performance, with each winglet 34, 36 having an airfoil shape.

The winglets 34, 36 may be connected to the pairs of blades 22 by various means including, without limitation, mechanical fasteners, chemical fasteners or the like. For example, a number of mechanical fasteners (e.g., screws) (not shown) may be inserted through a matching number of threaded bores (not shown) in the winglets 34, 36 to engaged a corresponding matching number of aligned, threaded bores (not shown) formed in the upper and lower ends of the blades 30, 32.

The winglets 34, 36 provide advantages by reducing turbulence, reducing the number of vortices that can form at the end of the blades 30, 32, and decreasing drag. In the instant embodiment, attaching winglets 34, 36 to the blades 30, 32 on the upper and lower ends of each pair of blades 22 also provides structural reinforcement to the pair of blades 22.

Each of the blades 30, 32 is rigidly connected to the central hub 28 by an upper arm assembly 38 and a lower arm assembly 40. The arm assemblies 38, 40 are coupled to the central hub 28 by means of mechanical coupling members allowing the pairs of blades 22 to rotate about the vertical axis O. The engagement of the pairs of blades 22 with the upper and lower arm assemblies 38, 40 defines an upper flow channel 42, a central flow channel 44, and a lower flow channel 46 for each pair of blades 22. These three (3) flow channels 42, 44, 46 increase the possibility of laminar flow and reduce the possibility for the turbulent motion. The three (3) flow channels 42, 44, 46 act as a slat and help keep the airflow attached to the wing, making it perform better and increasing the angle of efficiency.

The winglets 34, 36 also secure and stiffen the two ends of each pair of blades 22 so as to cancel deformations of the blades 30, 32 that can be produced by rotation, especially at high number of revolutions, in particular due to the centrifugal force upon the blades 30, 32 as the blades 30, 32 rotate about the vertical axis O. In the absence of the winglets 34, 36, as the pairs of blades 22 started to rotate faster and faster about the vertical axis O, the ends of the inner and outer blades 30, 32 would start to bend outwards from the vertical axis O and the central portion of the blades 30, 32 would start to bend inwards towards the vertical axis O. The deformation of the blades 30, 32 would result in displacement of the blades 30, 32 away from the vertical axis of the individual blades 30, 32, change the spatial relationship between the blades 30, 32, and result in deformation of the three (3) flow channels 42, 44, 46 between the two blades 30, 32 (this being harmful because, by modifying the geometry, the deformations negatively affect performance).

Each arm assembly 38, 40 includes three (3) arms 48, 50 extending away from the vertical axis O. Each arm is used to support a particular one of the pairs of blades 22. The upper and lower arm assemblies 38, 40 include structural winglets in the form of upper and lower arm winglets 52, 54 at distal ends of the arms 48, 50 that are sized and shaped to match the size and shape of at least the outward facing portion of the winglets 34, 36. The upper and lower arm assemblies 38, 40 supporting the inner and outer blades 30, 32 are designed to minimize turbulence and therefore the effect of “drag” during rotation. The arms 48, 50 of the upper and lower arm assemblies 38, 40 generally have a neutral aerodynamic effect but the upper and lower arm winglets 52, 54 disrupt the flow on the edges of the blades 30, 32 to minimize turbulence at the output (providing the “winglet effect”), decreasing the drag on each pair of blades 22. Additionally, by reducing turbulence in the output as the pairs of blades 22 rotate about the vertical axis O, the winglets allow the next pair of blades 22 to cross an air flow that is less turbulent as the next pair of blades 22 rotates through the previous position of the prior pair of blades 22.

Each of the upper and lower arm winglets 52, 54 include inner blade apertures 56, 60 and outer blade apertures 58, 62 that are sized and shaped to receive therethrough, respectively, the blades 32, 30 of a pair of blades 22 for securing the pairs of blades 22 to the upper and lower arm assemblies 38, 40. The outer and inner blades 30, 32 are positioned relative to the upper and lower arm winglets 52, 54 and secured thereto. The blades 30, 32 may be secured to the upper and lower arm winglets 52, 54 using a variety of methods including, mechanical fasteners, chemical fasteners or the like. In one example, a plurality of apertures may be formed in the blades 30, 32 that extend through the blades 30, 32 from the outer surfaces to the inner surfaces such that, when positioned within the apertures 56, 58, 60, 62, each blade 30, 32 has a plurality of apertures extending immediately above a top surface of the upper arm winglet 52, a plurality of apertures extending immediately below a bottom surface of the upper arm winglet 52, a plurality of apertures extending immediately above a top surface of the lower arm winglet 54, and a plurality of apertures extending immediately below a bottom surface of the lower arm winglet 54. Mechanical fasteners (e.g., pins, nuts and bolts, threaded rods, etc.) may then be inserted through the apertures to secure the blades 30, 32 in place relative to the upper and lower arm winglets 52, 54.

The lower arm assembly 40 further includes a central collar section 64 having upper and lower portions, defining a central space 65 therebetween, with coaxial upper and lower central apertures 66, 68 through which the central shaft 25 passes. The lower arm assembly 40 further includes three (3) wheels 70 located within the central space, operationally connected to the central collar section 25 and engaging the central shaft 25. The wheels 70 are evenly-spaced about the central shaft 25. The wheels 70 may be made from a coated-soft PVC material mounted on bearings. The wheels 70 are light-weight, and as the operating unit 26 rotates about the vertical axis O, the wheels 70 absorb the effects of resonance due to any imbalance of the rotating masses, as well as any structural resonance. The soft PVC wheels 70 engage the central shaft 25 but permit small tolerances, providing a savings in terms of structural stiffening and therefore weight.

The upper arm assembly 38 further includes a central collar section 74 having upper and lower portions, defining a central space 75 therebetween, with a coaxial lower central aperture 76 through which a stator shaft 78 passes. The stator shaft 78 is part of a disk-shaped outer rotor permanent magnet generator 80 disposed coaxial with the central shaft 25. The stator shaft 78 operationally engages the central shaft 25 and is coaxial therewith. The generator 80 engages the upper portion of the central collar section 74 and rotates therewith as the operating unit 26 rotates about axis O. The operating unit 26 is coaxial with the central shaft 25 about the axis O, and mounted thereon via a non-rotational bushing 82. The bushing 82 includes an outwardly extending upper lip 84 that engages a top end of the central shaft 25 with the main body of the bushing 82 sized and shaped to fit within a hollow interior of the central shaft 25. The stator shaft 78 is held in a fixed position by the bushing 82 and does not rotate about the axis O. As the blades 30, 32 cause the operating unit 26 to rotate about the axis O, the generator 80 rotates about the fixed stator shift 78, and generates electrical energy carried by the electrical cable 27 to a battery, electrical grid or the like. The electrical cable 27 goes out from the stator shaft 78 (passing inside the shaft 78) and through the support pole or central shaft 25 and arrives to a controller unit (not shown) through an opening in the central shaft 25. A number of mechanical fasteners 86 extend through apertures 88 in the central shaft 25 into bores 90 in the bushing 82 to further secure the bushing 82 in a fixed position relative to the central shaft 25.

As the rotor turns about the central shaft 25, the noise generated is lower than thirty (30) decibels (dB).

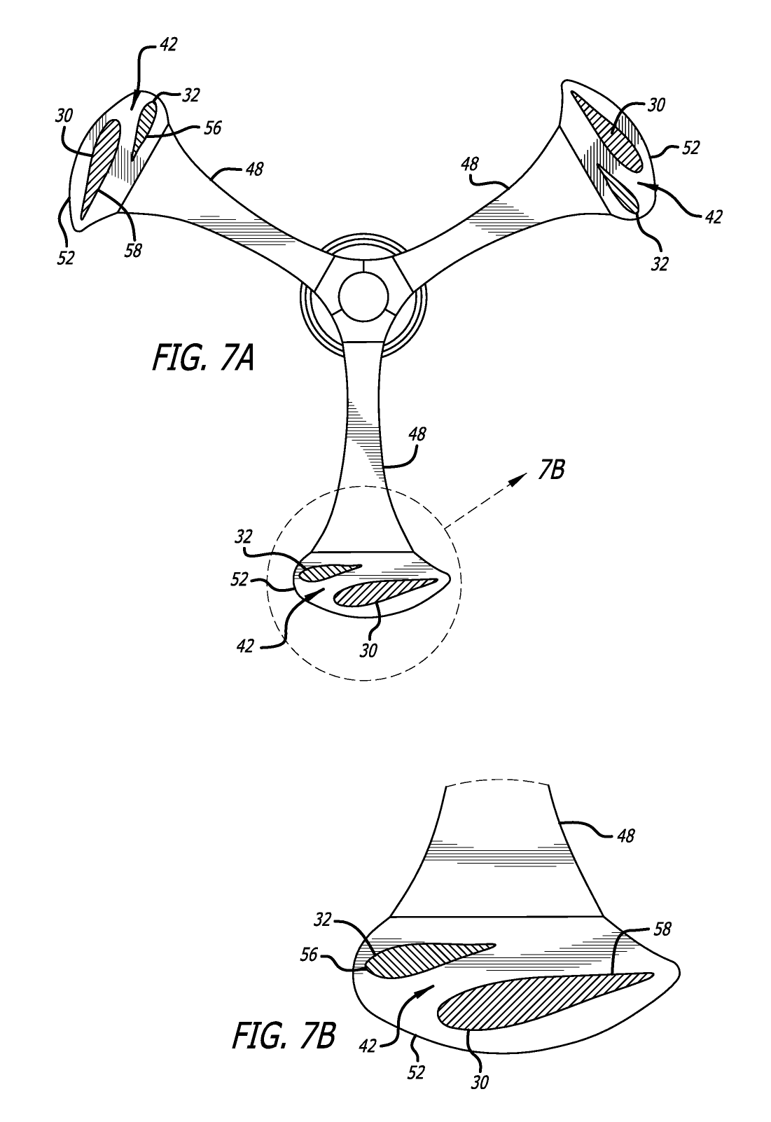

In another embodiment, as seen in FIGS. 6 and 7, a small flexible tab or flange 72 (acting as a Gurney Flap or wickerbill may be attached to the trailing edge of the outer blade 30, allowing the blade 30 to have more lift at low speed. The flange 72 is set at a right angle to the pressure side surface of the outer blade 30. The flange 72 increases pressure on the pressure side, decreases pressure on the suction side, and helps the boundary layer flow stay attached all the way to the trailing edge on the suction side of the outer blade 30. The flange 72 increases the downforce in front of a very small increase in aerodynamic drag. The effect of the flange 72 is to add a vertical component to the flow velocity at the trailing edge of the outer blade 30, creating greater downforce (a similar effect to that of increasing the wing incidence). Furthermore, the flange 72 slows the air flow above it, thus increasing the static pressure above the profile. Additionally, the flange 72 also has the effect of creating two counter-rotating vortices immediately behind the flap, causing a decrease in total pressure that helps to maintain the air flow attached to the surfaces of the blade profile, allowing the outer blade 30 to achieve greater angles of attack without causing a detachment of air flow and then stalling.

The flange 72 may be made of a flexible material (e.g., plastic, metal, a composite material or the like) which allows the flange 72 to align with the trailing edge of the outer blade 30 profile during high-speed rotation and to return to the same orthogonal position in low speed rotation.

The flange 72 may extend over the entire length of the trailing edge of the outer blade 30 of each pair of blades 22, reducing the angle of attack of the blades 30, 32 themselves, and reducing drag at high rotation speed, but without losing lift at low speed. This flexible flange 72 provides a performance boost at high rotation speeds, without impacting the ability of the assembly 20 to self-start at very low wind speeds.

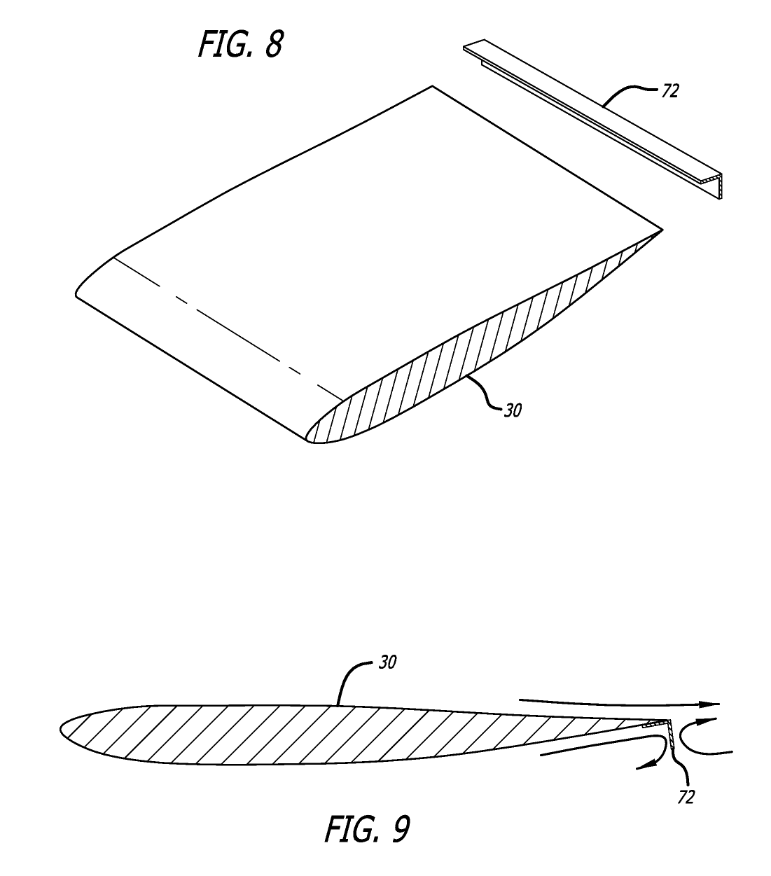

The spatial relationship between the blades 30, 32 of each pair of blades 22 is important in helping the assembly 20 to self-start at low speeds. As seen in FIG. 8, the inner blade 32 has a maximum chord length c1, and the outer blade 30 has a maximum chord length c2. In aeronautics, the term ‘chord’ refers to an imaginary straight line joining the leading and trailing edges of an airfoil, and the chord length is the distance between the trailing edge and the point on the leading edge where the chord intersects the leading edge. Point A indicates a position on the maximum chord c2 at a distance equal to ¼ of the maximum chord length from the leading edge of the outer blade 30. Point B indicates a position on the maximum chord c1 at a distance equal to ¼ of the maximum chord length from the leading edge of the inner blade 32. Furthermore, a first circumference having its center on the vertical axis O and passing through the point A of the outer blade 30 has a radius R1. A second circumference having its center on the vertical axis O and passing through the point B of the inner blade 32 has a radius R2. The angle created by segments R1 and R2 is indicated by angle β. The angle of incidence created between the prolongation the outer blade chord c2 and the prolongation of the inner blade chord c1 is indicated by angle γ. The distance between the point A of the outer blade 30 and the point B of the inner blade 32 is indicated by distance d.

The leading angle of incidence (i.e., the angular deviation between the direction of the resulting air flow and the maximum chord of the blade section) varies at most by ±40°, with λ=1.5 (the Tip Speed Ratio (TSR) identified by λ parameter is defined as the ratio between the tangential speed of the blades 30, 32 and the actual speed of the wind λ=(Ω*R)/v1) and drops to ±20°, with λ=3, it can be said that the wind deviation and distribution channels 42, 44, 46 defined by each of the pairs of blades 22, allows, in any condition and position, to the blade encountering first the wind to convey along the second one a flow that is able to increase the energy of the boundary layer, generating an increase in the lift coefficient up to 70%.

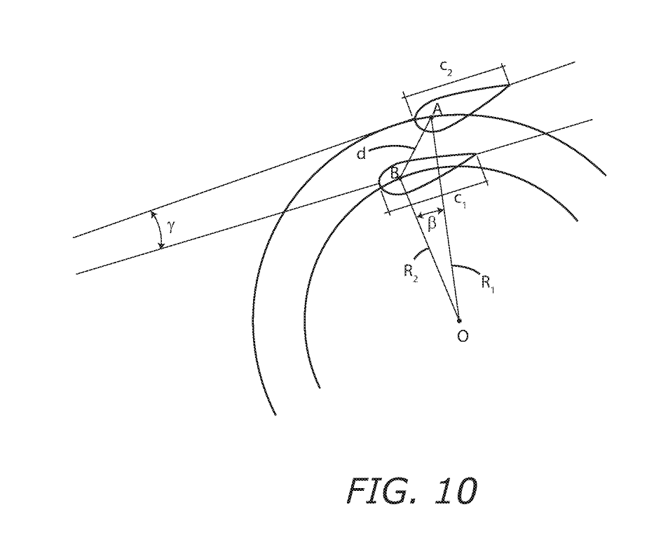

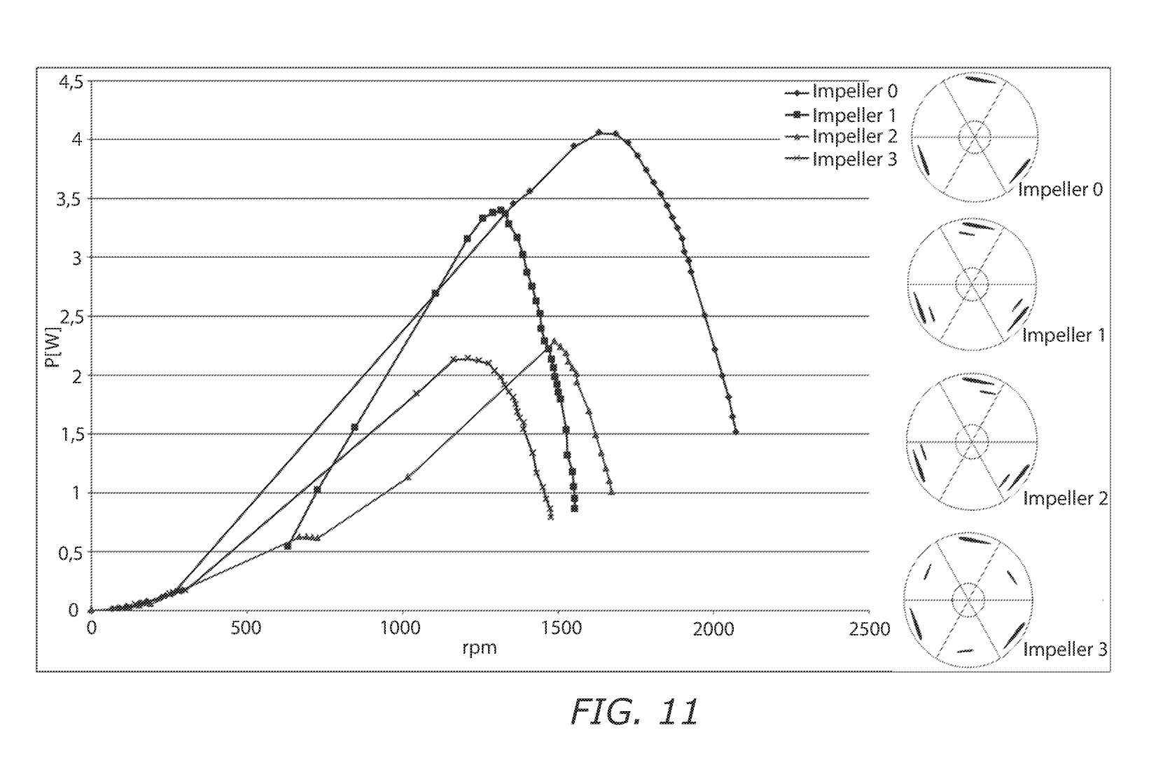

FIGS. 9-13 illustrate comparisons of the yields of various micro turbines arrangements with single and double blades arranged, respectively, in a first, a second and a third position. Particularly, the values shown in the diagrams of FIGS. 9-13 were obtained using vertical axis turbines having an impeller with a diameter 200 mm, a height of 150 mm, and a profile of DU 06W blades. Thus, the values shown in the diagrams of FIGS. 9-13, have been obtained using small size turbines (a 1:5 scaled turbine was used for the wind tunnel testing), but still suitable for experimental tests. The power coefficient or coefficient of power (CP) of the wind turbine is about 20% lower. A full-size micro turbine has a cp 0.24. The wind speed cannot be tested lower than 6 m/s because of the dimensions of the scaled turbine (e.g., 20×30 cm (1:5 scale)). In the real world, the wind speed starts from two (2) m/s (i.e., the wind speed at which the rotor of the turbine starts to turn).

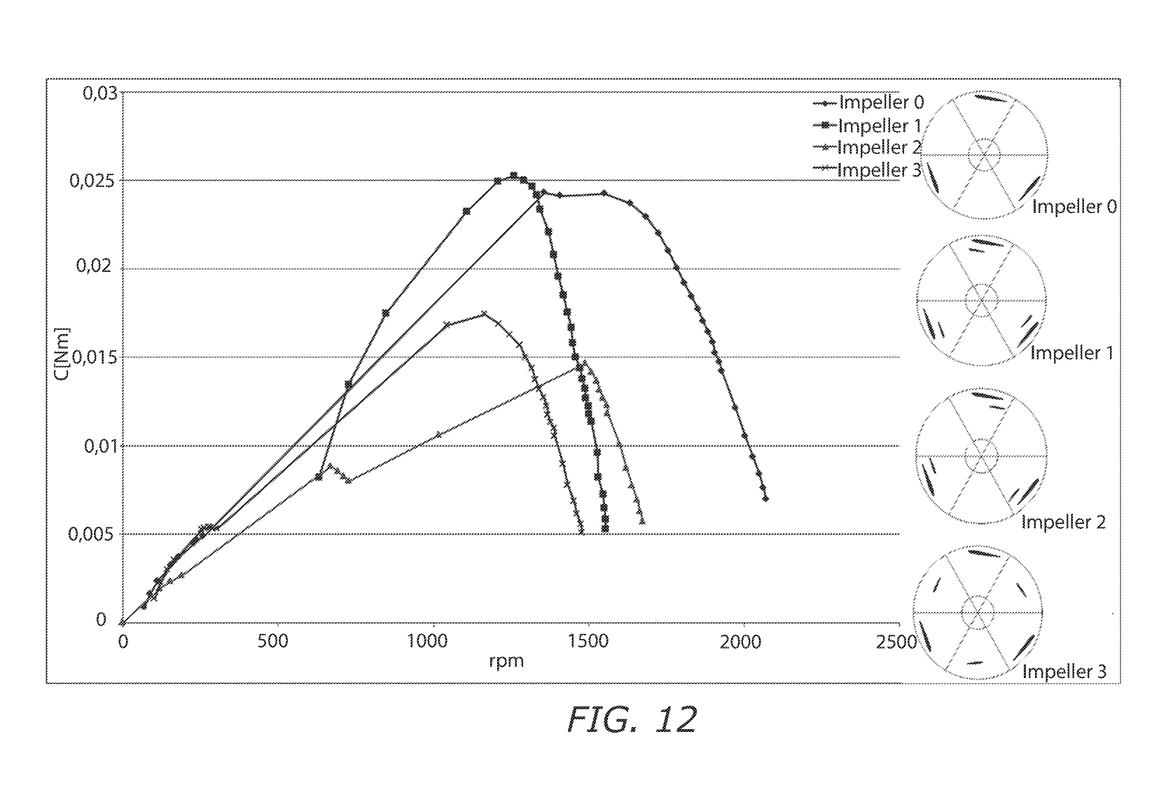

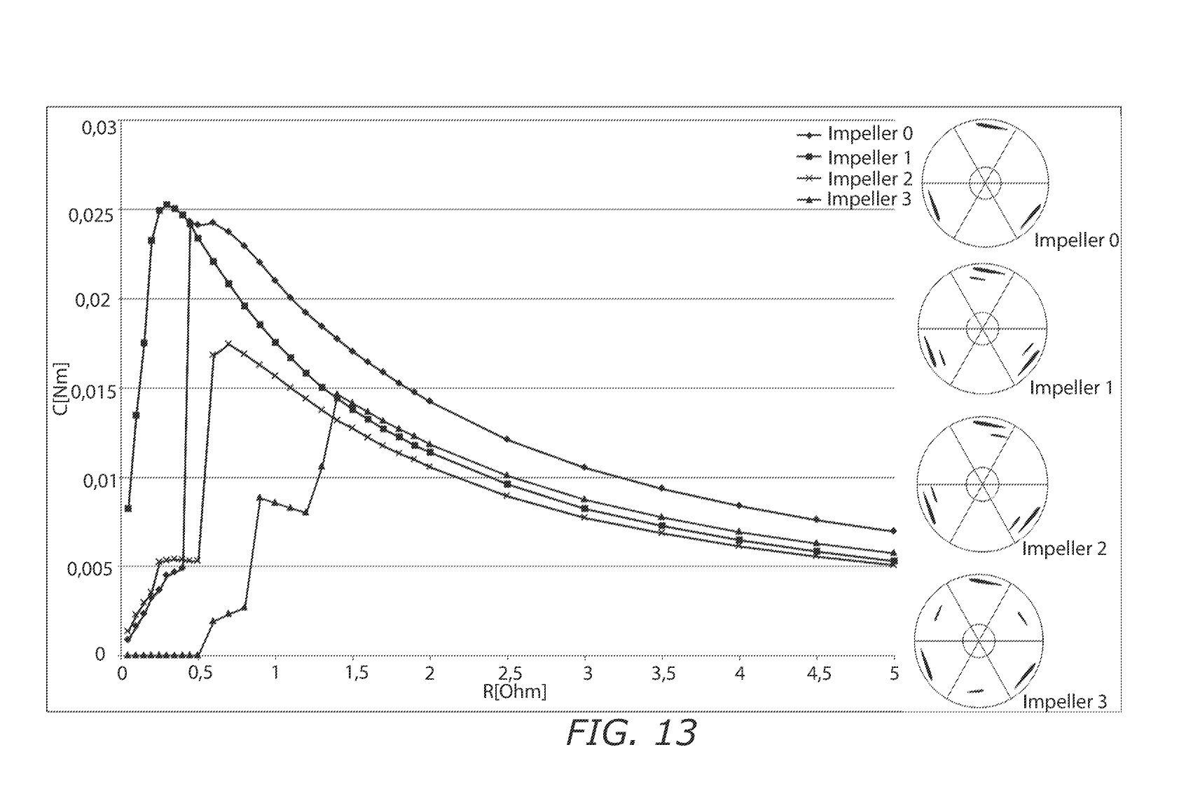

The wind regimes indicated in FIGS. 12 and 13 are higher than those that would be present in a full-size micro turbine, with a ratio that, just for illustrative reasons and in a first approximation, allows it to be equivalent to 10 m/s of the experimental tests to 2-3 m/s of a vertical axis full-size turbine.

FIGS. 9-11 show a comparison between rotor having a single blade arrangement in a vertical axis turbine, indicated as “Impeller 0”, and rotors having three different blade arrangements of vertical axis turbines with pairs of blades, indicated as “Impeller 1”, “Impeller 2”, “Impeller 3”. Particularly, the “Impeller 1” blade arrangement is the type seen in FIG. 1. The term “Impeller” is used in the diagrams to refer to a rotor/blade arrangement with each rotor/blade arrangement given its separate identification number (e.g., “Impeller 0,” “Impeller 1,” etc.).

FIGS. 12 and 13 show a comparison between the single blade same vertical axis turbine, indicated as “Impeller 0” and the same vertical axis turbine with pairs of blades, indicated as “Impeller 1”, of the previous figures.

Particularly, FIG. 12 illustrates the power, and it is put into evidence that the Impeller 1 has a constant continuous and growing up production from the minimum regimes, while for the Impeller 0 it is shown that up to the wind speed values of 10 m/s it is not obtained a sufficient torque to maintain the turbine under rotation, or in other words, the engine resistant torque is higher than lift torque of the impeller, even that instead of producing work, simply stops.

Making reference to the diagram of FIG. 13, once exceeded a minimum start-up wind at 10 m/s, the torque of the Impeller 0 follows, even remaining lower, that of the Impeller 1, confirming that it is not self-starting and that the torque is always lower, but in particular at low winds regimes.

Making reference to FIGS. 9-13, therefore, it is shown that, for a single blade vertical axis turbine and in different arrangements of vertical axis turbines with pair of blades, adjustment of said variables, i.e. R1 and R2 radiuses, of angle β between said radiuses, incident angle γ between the prolongation of the chords of the two blades comprising the pair, the length of the chords and the shape of the two blades determines the effectiveness of the flow diversion and distribution channel for controlling the turbulence and adhesion of “fluid fillets” on the back and on the front of the blade receiving them. In other words, the solution suggested according to the present invention does not exploit the Venturi effect which is established in the deflection and distribution channel of the flow between the two blades comprising the pair, but rather the laminar flow effect induced by the inner blade (or ancillary blade), resulting in a delay in the detaching of fluid fillets from the edge of the outer surface of the blade (or the bearing blade).

Furthermore according to the invention, the vertical axis turbine, with a plurality of pairs of straight (not twisted) blades, but configured so as to achieve a deflection and distribution channel of the wind flow, has a total lift greater than a similar turbine not having said channel and such that the start-up occurs at speeds lower than those necessary for the rotation of the above.

Particularly, the best results, in the range of TSR 0≤λ≤4, as far as torque and power are concerned, will occur when the following operating parameters are fulfilled:
1. ratio of the maximum blade chords: 0.10≤c1/c2≤1;
2. distance d: 0.5≤c1≤d≤2c2
3. angle γ: 0≤γ≤45°

Particularly, the best result achieved was obtained using the vertical axis turbines with an impeller diameter of 200 mm, an impeller height of 150 mm, and a profile of DU 06W blades where c1 equals 260 mm, c2 equals 125 mm, d equals 250 mm, and γ equals 30°.

In accordance with another embodiment of a vertical-axis turbine assembly having pairs of blades, the assembly includes devices able to allow to vary the blade arrangement so as to adapt the assembly to different wind conditions. As seen in FIG. 14, a micro-wind turbine in the form of a vertical axis wind turbine assembly 100 includes a plurality of pairs of blades 102. The assembly 100 includes a pedestal 104, and an operating unit 106 supported by and operationally engaging the pedestal 104. The operating unit 106 is configured to rotate about the vertical axis O.

The operating unit 106 includes a central hub 108, rotating around the vertical axis O, and three (3) pairs of blades 102 evenly spaced-apart from one another about the vertical axis O. Each pair of blades 102 includes an outer blade 110 and an inner blade 112. Both the outer blades 110 and the inner blades 112 have an airfoil shape with an inner surface facing towards the vertical axis O. The shape and dimensions of the blades 110, 112 are determined by the aerodynamic performance required to efficiently extract energy from the wind, and by the strength required to resist the forces on the blade 110, 112. The space between the outer blade 110 and the inner blade 112 of each pair of blades 102 defines an air flow diversion and distribution channel incident on the pair of blades 102. The blades 110, 112 may be made from various materials including, but not limited to, metal, plastic, carbon-fiber composites or the like. The outer blade 110 is larger than the inner blade 112.

The central hub 108 includes a top or upper plate 114 and a bottom or lower plate 116, separated from each other by a connecting rod 118 and arranged at right angles with respect to the vertical axis O. The upper plate 114 and the lower plate 116 are substantially, but not necessarily, circular and coaxial each other with respect to the vertical axis O.

Each outer blade 110 is disposed in a fixed manner, and is respectively coupled to an upper end disc 120 with its upper portion and to a lower end disc 122 with its lower portion. Each inner blade 112 is provided with an upper bracket and a lower bracket (not shown), provided in the part of the respective blade facing the vertical axis O and aligned according to the longitudinal extension of the blade 112.

Each of the inner blades 112 is rigidly connected to the central hub 108 by means of an upper articulated arm 124 and of a lower articulated arm 126. Each pair of blades 102 is evenly-spaced apart from the other pairs of blades 102 about the vertical axis O. Each of the upper articulated arms 124 is coupled on one end to the upper plate 114 and is coupled on another, opposite end to the upper bracket of a particular one of the inner blades 112. Likewise, each of the lower articulated arms 126 is coupled on one end to the lower plate 116, and is coupled on another, opposite end to the lower bracket of a particular one of the inner blades 112. Each upper articulated arm 124 includes a first portion 128 and a second portion 130. The first portion 128 is rotatable relative to the upper plate 114, and rotatable relative to the second portion 130. The second portion 130 is rotatable relative to the first portion 128, and rotatable relative to the upper bracket of the inner blade 112. Each lower articulated arm 126 includes a first portion 132 and a second portion 134. The first portion 132 is rotatable relative to the lower plate 116, and rotatable relative to the second portion 134. The second portion 134 is rotatable relative to the first portion 132, and rotatable relative to the lower bracket of the inner blade 112. The upper and lower articulating arms 124, 126 are, respectively, rotatable relative to the upper and lower brackets of the inner blades 112, as well as rotatable relative to the upper and lower plates 114, 116 due to mechanical coupling members (e.g., pins extending through apertures on ends of the portions 128, 130, 132, 134) allowing the rotation of the portions 128, 130, 132, 134 of the arms 124, 126 about respective vertical axes, parallel to the vertical axis O, so as to be able to vary, according to the specific angle of rotation about the respective axis, the assembly configuration of the upper and lower articulating arms 124, 126, and thus the operating unit 106 geometry, particularly the positioning of each inner blade 112 with respect to the corresponding outer blade 110 and to the central hub 108 (i.e., the radial distance between each inner blade 112 and the central hub 104, the angle of incidence of each inner blade 112, the angle between the leading edge of each outer blade 110 and the leading edge of each inner blade 112 with respect to the vertical axis O. Therefore, particularly, it is possible modifying the shape and the size of the deviation and distribution channel of the air flow, due to the positioning of the two blades comprising each single pair.

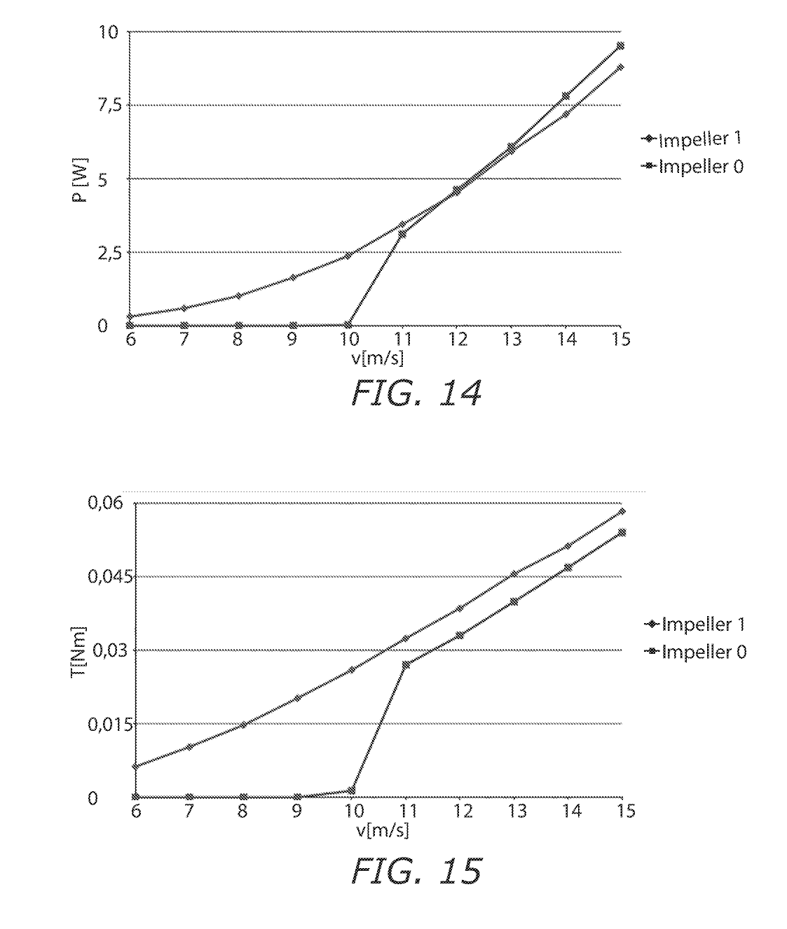

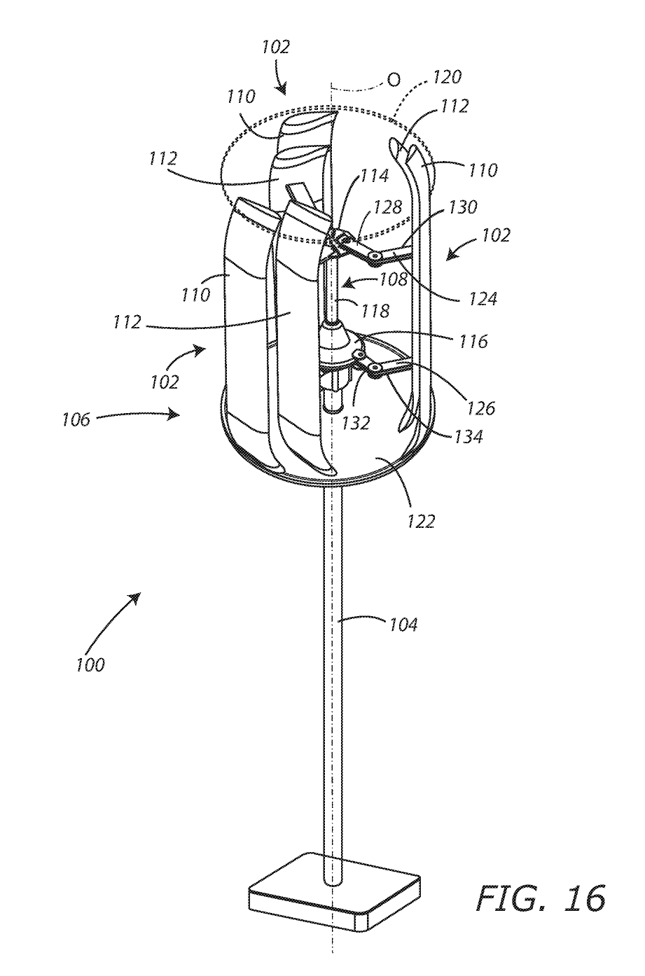

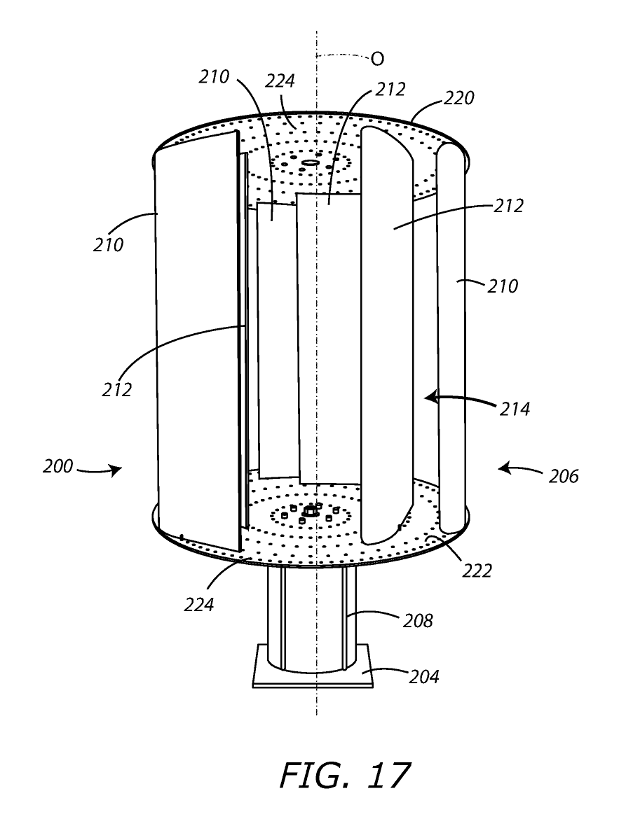

In accordance with an additional embodiment of a vertical-axis turbine assembly having pairs of blades. As seen in FIG. 15, a micro-wind turbine in the form of a vertical axis wind turbine assembly 200 includes a plurality of pairs of blades 202. The assembly 200 includes a pedestal 204, and an operating unit 206 supported by and operationally engaging the pedestal 204. The operating unit 206 is configured to rotate about the vertical axis O.

The operating unit 206 includes a central hub 208, rotating around the vertical axis O, and three (3) pairs of blades 202 evenly spaced-apart from one another about the vertical axis O. Each pair of blades 202 includes an outer blade 210 and an inner blade 212. Both the outer blades 210 and the inner blades 212 have an airfoil shape with an inner surface facing towards the vertical axis O. The shape and dimensions of the blades 210, 212 are determined by the aerodynamic performance required to efficiently extract energy from the wind, and by the strength required to resist the forces on the blade 210, 212. The space between the outer blade 210 and the inner blade 112 of each pair of blades 202 defines an air flow diversion and distribution channel 214 incident on the pair of blades 202. The blades 210, 212 may be made from various materials including, but not limited to, metal, plastic, carbon-fiber composites or the like. The outer blade 210 is larger than the inner blade 212.

The central hub 208 includes a top or upper end plate or disc 220 and a bottom or lower end plate or disc 222, arranged orthogonally with respect to the vertical axis O and separated by the three (3) pairs of blades 202. The lower end plate 222 is fixed to the central rotatable hub 208. The upper end plate 220 and the lower end plate 222 are substantially, but not necessarily, circular and coaxial each other with respect to the vertical axis O.

Both end discs 220, 222 include a plurality of holes 224. The holes 224 can be arranged to form a plurality of concentric rings of holes centered about the vertical axis O, allowing the pairs of blades 202 to be arranged and oriented by means of mechanical connecting members (e.g., mechanical fasteners including, but not limited to, pins, bolts, screws, etc.) inserted through selected holes 224 (and removably secured therein) so as to hold each blade 210, 212 of each pair of blades 202 in a particular orientation. As the mechanical fasteners are removable, the blades 210, 212 can be re-positioned and/or re-oriented, allowing a user to vary the assembly configuration of the blades 210, 212, and consequently the geometry of the operating unit 206, particularly the relative positioning of each inner blade 212 with respect to the corresponding outer blade 210, and of each inner blade 212 and of each outer blade 210 with respect to the central hub 208, the radial distance between each inner blade 212 and outer blade 210 with respect to the central hub 208, the angle of incidence of each inner blade 212 and outer blade 210, and the angle created between the leading edge of each outer blade 210 and the leading edge of each inner blade 212 with respect to the vertical axis O. Therefore, it is possible to modify the shape and the size of the deviation and distribution channel 214 of the air flow, due to the positioning of the two blades 210, 212 comprising each single pair of blades 202.

In a further embodiment of a vertical-axis wind turbine assembly having pairs of blades also includes an automated mechanism for adjusting the position of the blades 210, 212 of each pair of blades 202, to allow a change of the blade arrangement of the turbine without a user having to directly access the turbine itself. The automated mechanism may be connected to a control station, provided with a control mechanism by an operator and/or with automated control mechanism. In particular, the automated mechanism can be connected to an electronic processor, connected to an anemometer and able to determine the optimal blade configuration of the turbine depending on the wind conditions (e.g., wind speed). For example, portions of each articulated arm can be controlled by an electronic processor operationally connected to the anemometer for adjusting positions of the inner blade relative to the outer blade upon detecting a change in, for example, wind speed. Various motors or the like may be used to rotate one portion of an articulated arm relative to another portion and/or relative to the rotor, so as to orient the inner blade in a position relative to the outer blade best able to exploit the current wind conditions. The automated mechanism may be implemented using software, firmware, hardware (e.g., fixed logic circuitry), or a combination of these implementations. The terms “logic,” “module,” “component,” “system” and “functionality,” as used herein, generally represent software, firmware, hardware, or a combination of these elements. For instance, in the case of a software implementation, the terms “logic,” “module,” “component,” “system,” and “functionality” represent program code/instructions that performs specified tasks when executed on a processing device or devices (e.g., CPU, CPUs or processor(s)). The program code can be stored at locations in one or more computer readable memory devices such as random access memory, disc drives or their equivalents. The logic, modules, components, systems, and functionality may be located at a single site (e.g., as implemented by a single processing device), or may be distributed over a plurality of locations and interconnected by a network. The automated mechanism may be implemented as a computer process (method), a computing system, or as an article of manufacture, such as a computer program product or non-transitory computer-readable media. The term “machine-readable media” and the like refers to any kind of non-transitory medium for retaining information in any form, including various kinds of storage devices (magnetic, optical, static, etc.). Machine-readable media also encompasses transitory forms for representing information, including various hardwired and/or wireless links for transmitting the information from one point to another. The computer program product may be computer storage media, readable by a computer device, and encoding a computer program of instructions for executing a computer process. The computer program product may also be a propagated signal on a carrier, readable by a computing system, and encoding a computer program of instructions for executing a computer process.

The above-described embodiments are independent from any aerodynamic conditions, and can operate with both lift and drag; making the above-described embodiments highly adaptable to on-site specifics faced by each individual turbine. The turbine embodiments have been designed and optimized so that the turbine structure is minimal and generates little noise while at work, so that any one or more of the embodiments can be applied in both urban and suburban households without negative implications for the local environment (or property values).

Accordingly, as can be noted from the above specification, the above-described embodiments of the micro-wind turbine allow a user to take maximum advantage of the wind potential at low regime, using the deviation and distribution channel defined between the inner and outer blades of each pair of blades (realized by the positioning of the particular two (i.e., inner and outer) blades forming each pair of blades, so as to exploit the laminar fluid effect created, under certain conditions, within the deviation and distribution channel(s), so that the turbine is self-starting at very low wind speeds.

Accordingly, as can be noted from the above specification, the above-described embodiments of the micro-wind turbine allow a user to vary the geometry of the turbine in terms of relative positioning of each pair of the inner and outer blades, and consequently the form and dimensions of the deviation and distribution channel of the wind flow, in a simple and fast way.

The variation of the shape and of the size of the deviation and distribution channel of the wind flow of each pair of blades determines a different path of the wind flow lines with respect to the latter one. Accordingly, by suitably varying the shape and the size of the deviation and distribution channel of the wind flow of each pair of blades, it is possible to modify the kinematics of the micro-wind turbine described above, in order to exploit the kinematic characteristics of the wind in the environment surrounding the micro-wind turbine.

Although the present invention has been discussed above in connection with micro-wind turbine, the present invention is not limited to micro-turbines, and the principles discussed above may be extended, without limitation, to large-scale wind turbines, wind turbines with higher output powers and the like.

In addition, the claimed invention is not limited in size and may be constructed in miniature versions or for use in very large-scale applications in which the same or similar principles of motion as described above would apply. For example, a miniature version of the micro-turbine assembly disclosed above can be used to power a meteorological station. Likewise, the length and width of the various features of the wind turbine are not to be construed as drawn to scale, and that the lengths/widths of the various components of the wind turbine may be adjusted in conformance with the area available for placement of the wind turbine. For example, the micro-wind turbine disclosed above may be sized and shaped to be positioned on the window sill of a dwelling. The micro-wind turbine may be provided as a compact system in an IKEA-style kit that can be assembled and installed by the user. Furthermore, the figures (and various components shown therein) of the specification are not to be construed as drawn to scale.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

The use of the expression “at least” or “at least one” suggests the use of one or more elements or ingredients or quantities, as the use may be in the embodiment of the disclosure to achieve one or more of the desired objects or results.

The numerical values mentioned for the various physical parameters, dimensions or quantities are only approximations and it is envisaged that the values higher/lower than the numerical values assigned to the parameters, dimensions or quantities fall within the scope of the disclosure, unless there is a statement in the specification specific to the contrary.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Spatially relative terms, such as “front,” “rear,” “left,” “right,” “inner,” “outer,” “beneath”, “below”, “lower”, “above”, “upper” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

The above description presents the best mode contemplated for carrying out the present invention, and of the manner and process of making and using it, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A wind turbine with a vertical axis, comprising:
a base;
a central shaft; and
a rotor operationally engaging the central shaft, rotatable relative thereto, and coaxial therewith about the vertical axis; wherein the rotor includes a plurality of pairs of blades, each pair of blades including a larger outer blade and a smaller inner blade,
whereby the outer and inner blades define at least one diverting and distribution channel for a laminar flow effect induced by the inner blade against the outer blade, involving a delay in the detachment of the air flow from the edge of the surface of the outer blade, allowing the turbine to operate in wind having a speed about 2 m/s.

2. The wind turbine of claim 1, further comprising a TSR range of 0≤λ≤4, in which TSR indicates the ratio of the tangential speed of the blades and the actual speed of the wind, wherein the operative parameters of the pairs of blades include: the ratio of a maximum chord of the outer blade c2 and a maximum chord of the internal blade c1 is equal to: 0.10≤c1/c2≤1; wherein a distance d between point A, located on the maximum chord of the outer blade at a distance equal to ¼ of the maximum chord c2 from a leading edge of the outer blade, and point B, located on the maximum chord of the inner blade at a distance equal to ¼ of the maximum chord c1 from the leading edge of the inner blade is equal to: 0.5c1≤d≤2c2; and wherein an angle of incidence γ formed between an extension of the maximum chord of the outer blade and the extension of the maximum chord of the inner blade is: 0≤γ≤45°.

3. The wind turbine of claim 1, wherein the inner blade of each pair of blades operationally engages the rotor in a manner that allows a position of the inner blade to be adjusted relative to a position of the outer blade.

4. The wind turbine of claim 3, wherein the rotor includes a plurality of articulated arms, wherein each arm operationally connects a particular one of the pairs of blades to the rotor.

5. The wind turbine of claim 4, wherein movement of the articulated arms is controlled by an electronic processor operationally connected to an anemometer for adjusting positions of the inner blade relative to the outer blade upon detecting a change in wind speed.

6. The wind turbine of claim 1, wherein the rotor includes an upper arm assembly and a lower arm assembly, wherein each arm assembly includes a plurality of arms, wherein each arm engages a particular one of the pairs of blades.

7. The wind turbine of claim 6, wherein each arm of the plurality of arms includes a winglet at an end distal from the central shaft, wherein each blade of a particular pair of blades associated with a particular arm extends through and operationally engages the winglet associated that particular arm.

8. The wind turbine of claim 1, wherein the rotor includes a plurality of wheels disposed about the vertical axis, and wherein each wheel operationally engages an external surface of the central shaft.

9. The wind turbine of claim 1, wherein each pair of blades includes an upper winglet attached to top surfaces of the inner and outer blades, and a lower winglet attached to the bottom surfaces of the inner and outer blades.

10. The wind turbine of claim 1, wherein each outer blade of the pairs of blades includes a flange extending laterally away from a trailing edge of the outer blade, whereby the flange acts as a Gurney Flap.
